(19) United States
(12) Patent Application Publication
(10) Pub. No.: US 2006/0067580 A1
(43) Pub. Date: Mar. 30, 2006

(54) Consumer electronic device supporting navigation of multimedia content across multiple camera views of a scene

(76) Inventors: C.C. Lee, Pleasanton, CA (US); Mohammed Zubair Visharam, Santa Clara, CA (US); Ali Tabatabai, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/932,658

(22) Filed: Sep. 1, 2004

(51) Int. Cl. G06K 9/36; G06F 9/44

(52) U.S. Cl. 382/232; 719/322

(57) ABSTRACT

A consumer electronic device includes a storage sub-system to store multimedia data associated with multiple camera views of a scene and metadata describing the multimedia data in separate tracks defined by a media file format. Each of the separate tracks corresponds to one of the multiple camera views of the scene. The consumer electronic device also includes a content processor to switch between the multiple camera views at run time using the metadata stored in the separate tracks.

### FIELD OF THE INVENTION

The invention relates generally to the storage and retrieval of audiovisual content in a multimedia file format, and particularly to consumer electronic devices supporting navigation of multimedia content across multiple camera views of a scene.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2004, Sony Electronics, Inc., All Rights Reserved.

### BACKGROUND OF THE INVENTION

In the wake of rapidly increasing demand for network, multimedia, database and other digital capacity, many multimedia coding and storage schemes have evolved. One of the well known file formats for the storage of audiovisual data is the QuickTime® file format developed by Apple Computer Inc. The QuickTime file format was used as the starting point for creating the International Organization for Standardization (ISO) base media file format, ISO/IEC 14496-12, Information Technology—Coding of audio-visual objects—Part 12: ISO Base Media File Format (also known as the ISO file format), which was, in turn, used as a template for two standard file formats: (1) For an MPEG-4 file format developed by the Moving Picture Experts Group, known as MP4 (ISO/IEC 14496-14, Information Technology—Coding of audio-visual objects—Part 14: MP4 File Format); and (2) a file format for JPEG 2000 (ISO/IEC 15444-1), developed by Joint Photographic Experts Group (JPEG).

The ISO base media file format provides capabilities to store media data along with metadata. Each meta data stream is referred to as a track. The media data for a meta data track can be, for example, video data, audio data, binary format screen representations (BIFS), etc. Each track is further divided into samples (also known as access units or pictures). A sample represents a unit of media data at a particular time point. Metadata for the media data is stored in the form of tracks. Metadata tracks provide declarative, structural and temporal information about the media data. For example, a metadata track may contain information describing sample sizes, decoding times, composition times and random accessibility of its associated media data. An application such as a player, a server or a transcoder may use information stored in a metadata track to access different parts of the associated media data.

### SUMMARY OF THE INVENTION

A consumer electronic device includes a storage sub-system to store multimedia data associated with multiple camera views of a scene and metadata describing the multimedia data in separate tracks defined by a media file format. Each of the separate tracks corresponds to one of the multiple camera views of the scene. The consumer electronic device also includes a content processor to switch between the multiple camera views at run time using the metadata stored in the separate tracks.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of an encoding system;

FIG. 2 is a block diagram of one embodiment of a decoding system;

FIG. 3 is a block diagram of a computer environment suitable for practicing the invention;

FIG. 4 illustrates an exemplary data structure for storing data pertaining to multiple camera views of a scene;

FIG. 5 is a flow diagram of one embodiment of a process for switching between different camera views of a scene;

FIG. 6 is a flow diagram of one embodiment of a process for performing a switching request pertaining to a real time mode;

FIG. 7 is a flow diagram of one embodiment of a process for performing a switching request pertaining to a pause mode;

FIG. 8 is a block diagram of one embodiment of a consumer electronic device supporting switching between multiple camera views of a scene; and

FIG. 9 is a flow diagram of one embodiment of a process for switching between different camera views using a consumer electronic device.

### DETAILED DESCRIPTION OF THE INVENTION

In the following detailed description of embodiments of the invention, reference is made to the accompanying drawings in which like references indicate similar elements, and in which is shown, by way of illustration, specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

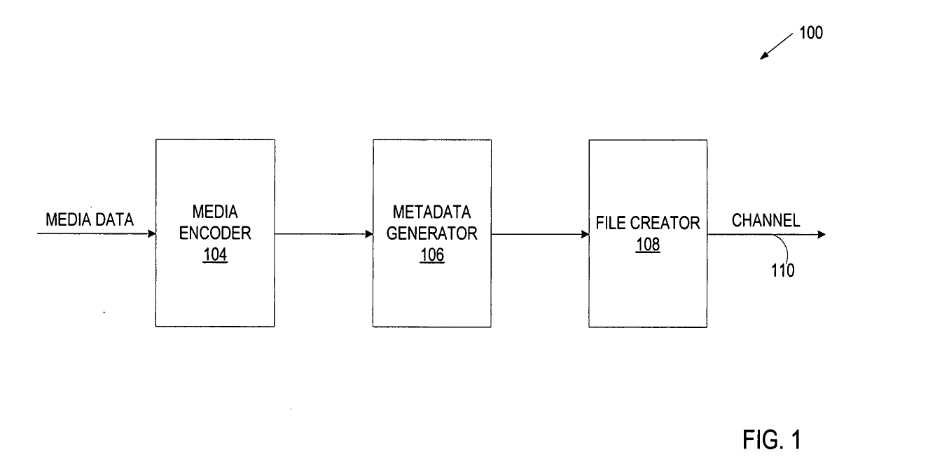

Beginning with an overview of the operation of the invention, FIG. 1 illustrates one embodiment of an encoding system 100. The encoding system 100 includes a media encoder 104, a metadata generator 106 and a file creator 108.

The media encoder 104 is responsible for receiving media data (video data, audio data, synthetic objects, or any combination of the above), coding the media data and passing it to the metadata generator 106. The media data includes data streams associated with multiple views of a scene that are captured by cameras at different angles. The media encoder 104 may consist of a number of individual encoders or include sub-encoders to process various types of media data.

The metadata generator 106 generates metadata for each data stream associated with a single camera view of the scene. The metadata provides information about the media data according to a media file format. The media file format may be derived from the ISO base media file format (or any of its derivatives such as MPEG-4, JPEG 2000, etc.), QuickTime or any other media file format, and also include some additional data structures. The metadata provides information describing sample sizes, decoding times, composition times and random accessibility of associated media data. In one embodiment, the metadata created for each camera view a random access table (also referred to herein as a synchronization table) containing a list of random access frames (also referred to as random access samples) within the media data of a corresponding camera view. A random access frame is a frame encoded independently of any other frames. Hence, a random access frame contains sufficient data to allow for reproduction of the image embodied in the frame without requiring data from other frames. In one embodiment, the metadata of each camera view also a timestamp table that provides the timestamps for the random access frames in the random access table.

The file creator 108 stores the metadata created for each camera view in a separate track of a media format file. Each track is assigned a unique identifier and linked to a relevant camera position. In one embodiment, the file contains both the coded media data and metadata pertaining to that media data (e.g., the file tracks with media data of different camera views and tracks with metadata describing the media data of different camera views). Alternatively, the coded media data is included partially or entirely in a separate file and is linked to the metadata by references contained in the metadata file (e.g., via URLs). The file created by the file creator 108 is available on a channel 110 for storage or transmission.

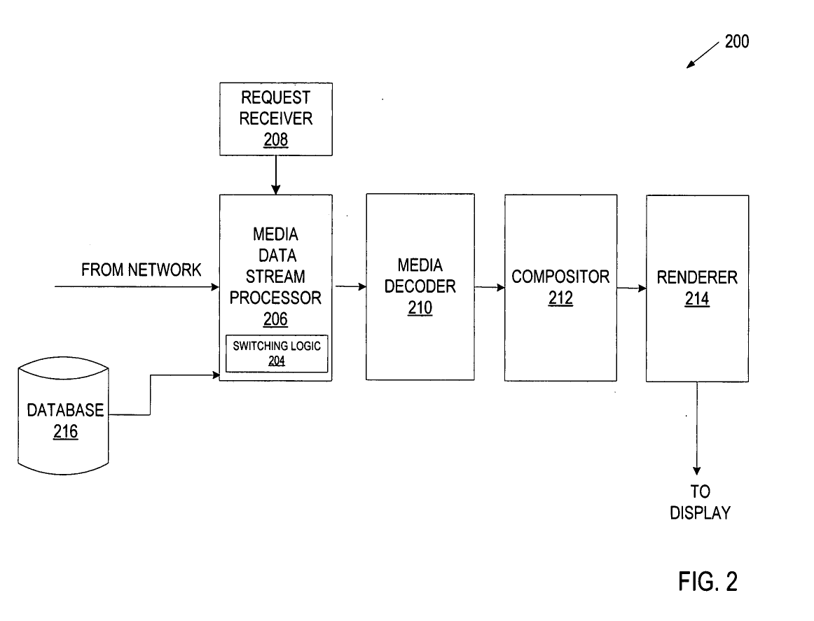

FIG. 2 illustrates one embodiment of a decoding system 200. The decoding system 200 a request receiver 208, a media data stream processor 206, a media decoder 210, a compositor 212, a renderer 214, and a data store 216. The decoding system 200 may reside on a client device. Alternatively, the decoding system 200 may have a server portion and a client portion communicating with each other over a network (e.g., Internet). The server portion may include the media data stream processor 206 and the request receiver 208. The client portion may include the media decoder 210, the compositor 212 and the renderer 214.

The decoding system may process a media format file stored in the data store 216 or received over a network (e.g., from the encoding system 100). The media format file (e.g., MP4 format file, ISO base format file, etc.) includes metadata describing the media data associated with multiple views of a scene that are captured by cameras at different angles. The metadata of each camera view is stored in a separate track. In one embodiment, the media data is included in the same media format file as the metadata. In another embodiment, the media data is included partially or entirely in a separate file and is linked to the metadata by references contained in the metadata file (e.g., via URLs).

The media data stream processor 206 is responsible for receiving the media format file, extracting metadata from the media format file, and using the metadata to form a media data stream to be sent to the media decoder 210. In one embodiment, the media data stream processor 206 forms the media data stream based on content requests received by the request receiver 208. The request receiver 208 may receive a content request from a user (e.g., via a user interface) or an application program (e.g., via an application programming interface (API)). A content request requires switching between camera views at run time. In one embodiment, the media data stream processor 206 includes switching logic 204 that is responsible for forming a data stream in accordance with a switching request, as will be discussed in more detail below.

Once the media data stream is formed, it is sent for decoding to the media decoder 210 either directly (e.g., for local playback) or over a network (e.g., for streaming data). The media decoder 210 may be a real time MPEG-4 decoder or any other real time media data decoder.

The compositor 212 receives the output of the media decoder 210 and composes a scene. In one embodiment, the switching logic 204 instructs the compositor 212 to refrain from including certain decoded frames into the scene, as will be discussed in more detail below. The composed scene is then rendered on a user display device by the renderer 214. In an alternative embodiment (not shown), the renderer 214 is replaced by a transmitter, which transmits the composed scene to an external display system for presentation to the user.

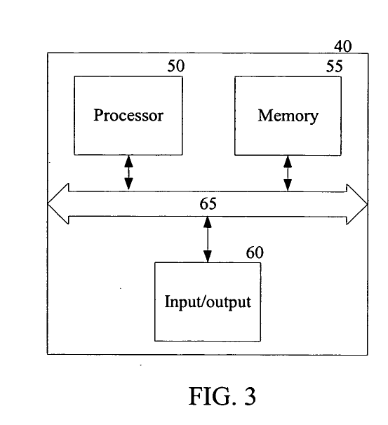

The following description of FIG. 3 is intended to provide an overview of computer hardware and other operating components suitable for implementing the invention, but is not intended to limit the applicable environments. FIG. 3 illustrates one embodiment of a computer system suitable for use as an encoding system 100 of FIG. 1, a decoding system 200 of FIG. 2, or any of their components.

The computer system 340 includes a processor 350, memory 355 and input/output capability 360 coupled to a system bus 365. The memory 355 is configured to store instructions which, when executed by the processor 350, perform the methods described herein. Input/output 360 also encompasses various types of computer-readable media, including any type of storage device that is accessible by the processor 350. One of skill in the art will immediately recognize that the term “computer-readable medium/media” further encompasses a carrier wave that encodes a data signal. It will also be appreciated that the system 340 is controlled by operating system software executing in memory 355. Input/output and related media 360 store the computer-executable instructions for the operating system and methods of the present invention. The encoding system 100, the decoding system 200, or their individual components may be separately coupled to the processor 350, or may be embodied in computer-executable instructions executed by the processor 350. In one embodiment, the computer system 340 may be part of, or coupled to, an ISP (Internet Service Provider) through input/output 360 to transmit or receive media data over the Internet. It is readily apparent that the present invention is not limited to Internet access and Internet web-based sites; directly coupled and private networks are also contemplated.

It will be appreciated that the computer system 340 is one example of many possible computer systems that have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

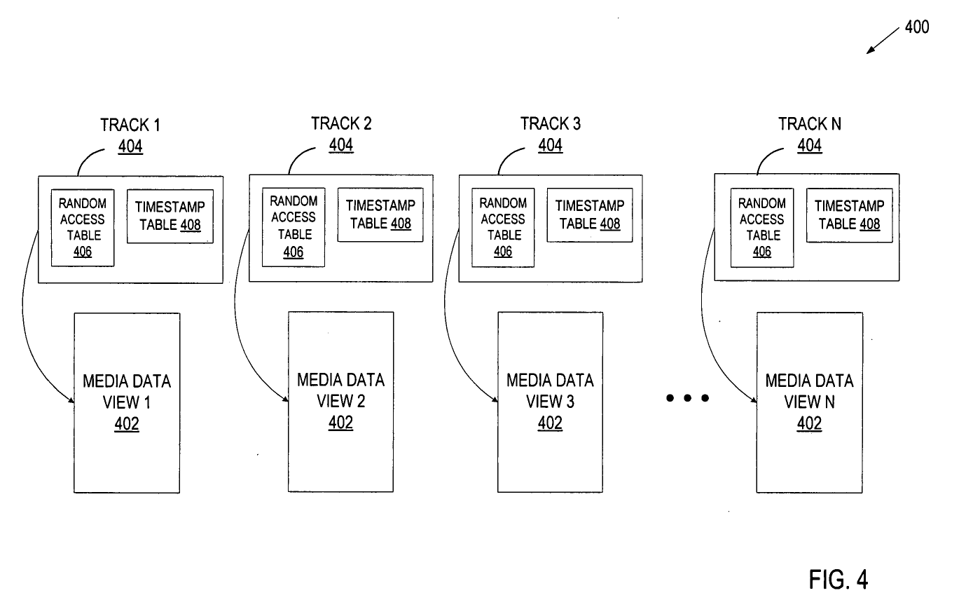

FIG. 4 illustrates an exemplary data structure for storing data pertaining to multiple camera views of a scene.

Referring to FIG. 4, the data structure 400 includes a set of tracks 402 to store media data of different camera views of the scene and a set of tracks 404 to store metadata data describing the media data of the different camera views. Each track 404 is assigned a unique identifier that is associated with a relevant camera position that is linked to a corresponding media data track 402 through internal referencing. The metadata in each track 404 contains information describing sample sizes, decoding times, composition times and random accessibility of associated media data. In particular, the metadata of each track 404 includes a random access table 406 containing a list of random access frames within the media data of a corresponding camera view. A random access frame is a frame encoded independently of any other frames. Hence, a random access frame contains sufficient data to allow for reproduction of the image embodied in the frame without requiring data from other frames. In one embodiment, the metadata of each track 404 also includes a timestamp table 408 providing timestamps for the random access frames from the random access table 406.

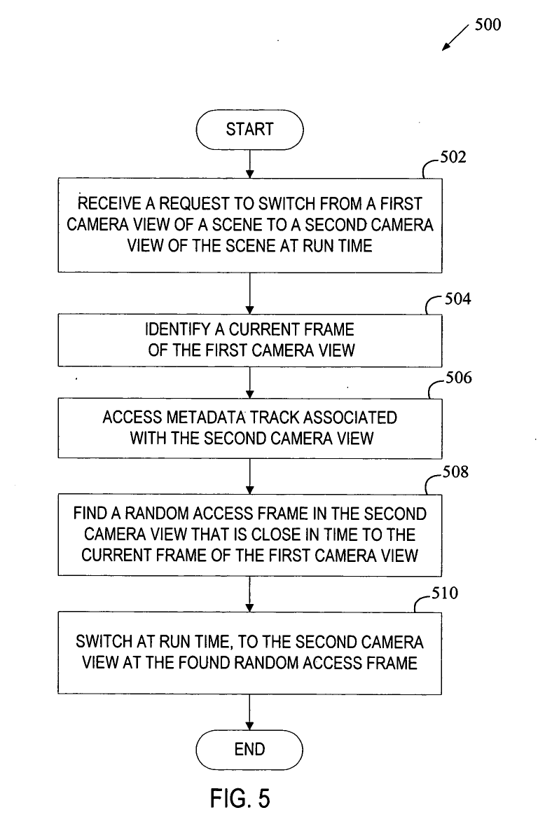

FIGS. 5-7 and 9 illustrate processes for switching between multiple camera views. The processes may be performed by processing logic that may comprise hardware (e.g., circuitry, dedicated logic, etc.), software (such as run on a general purpose computer system or a dedicated machine), or a combination of both. For software-implemented processes, the description of a flow diagram enables one skilled in the art to develop such programs including instructions to carry out the processes on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the embodiments of the present invention are not described with reference to any particular programming language. It will be appreciated that a variety of programming languages may be used to implement the teachings described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer operations may be incorporated into the processes illustrated in FIGS. 5-7 and 9 without departing from the scope of the invention and that no particular order is implied by the arrangement of blocks shown and described herein.

FIG. 5 is a flow diagram of one embodiment of a process 500 for switching between different camera views of a scene. In one embodiment, process 500 is performed by switching logic 204 of FIG. 2.

Initially, process 500 begins with processing logic receiving a request to switch from a first camera view of a scene to a second camera view of the scene (processing block 502). The request may be specified by a user (e.g., via a user interface) or an application program (e.g., via an API). The first camera view of the scene is the view currently presented to the user. The second camera view is any other view of the scene captured by a camera at a different angle. The switching request may identify the second camera view by a desired camera position, by a view number, or by some other unique information. In one embodiment, the switching request is received at run time (e.g., while presenting video data to the user). The switching request may pertain to a pause mode (e.g., the user may want to view the currently-displayed frame(s) but captured by a camera at a different angle) or a real-time mode (e.g., the user may want to continue viewing the scene at a different camera position).

At processing block 504, processing logic identifies a current frame of the first camera view (i.e., the frame presented to the user at the time of the request).

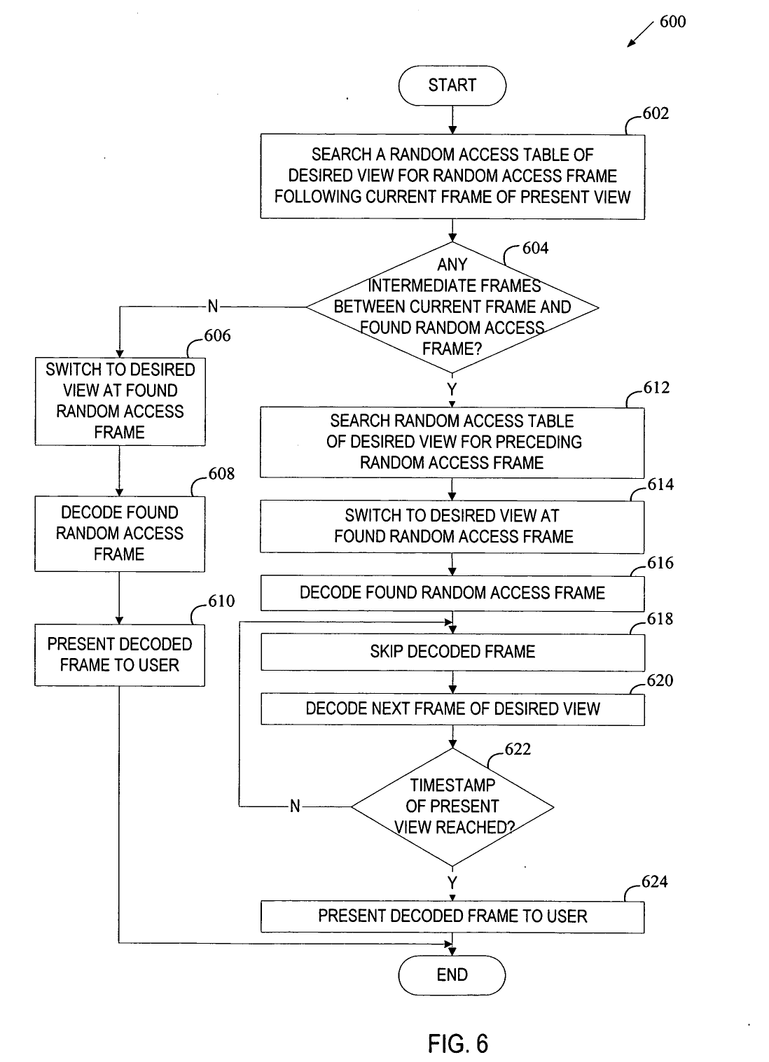

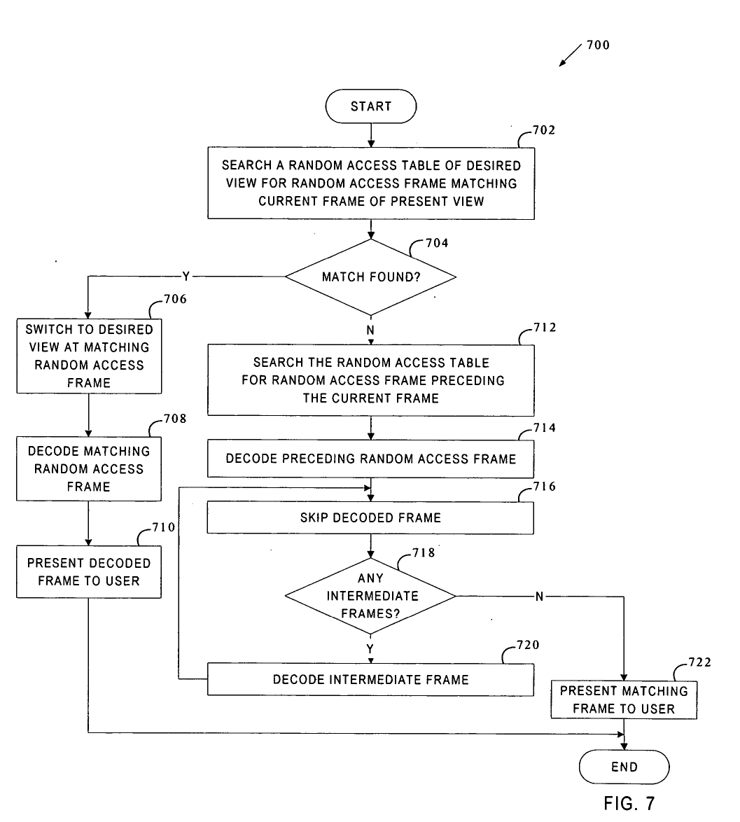

Next, processing logic accesses a metadata track associated with the second camera view (processing block 506) and, in one embodiment, finds a previous random access frame of the second camera view that is close in time to the current frame of the first camera view (processing block 508). In one embodiment, processing logic finds a close random access frame by searching the random access table stored in the metadata track of the second camera view. Depending on the mode (e.g., pause or real-time) associated with the request, processing logic may search for a random access frame matching the current frame (e.g., in terms of frame numbers or timestamps) or immediately preceding or following the current frame. Exemplary embodiments of searching for a close random access frame of the second camera view are discussed in greater detail below in conjunction with FIGS. 6 and 7.

At processing block 510, processing logic switches to the second camera view at the random access frame found at processing block 508, and provides to the decoder (e.g., a media decoder 210 of FIG. 2) frames of the second camera view, beginning with the found random access frame. As will be discussed in more detail below, in one embodiment, processing logic also determines that some of the decoded frames do not need to be displayed (e.g., if one or more intermediate frames exist between the found random access frame and the current frame of the first camera view) and provides appropriate display information (e.g., the frame number or timestamp prior to which the decoded frames should be skipped) to a scene compositor (e.g., a compositor 212 of FIG. 2).

FIG. 6 is a flow diagram of one embodiment of a process 600 for performing a switching request pertaining to a real time mode. In one embodiment, process 600 is performed by components of a decoding system 200 (in particular, switching logic 204, a media decoder 210, a compositor 212, and a renderer 214) of FIG. 2.

Initially, process 600 begins with processing logic searching a random access table in a metadata track of a desired camera view for the nearest random access frame that follows the current frame of the presently displayed camera view (processing block 602). The nearest random access frame is a random access frame that is close in time to the current frame, as may be reflected by its frame number or timestamp.

At processing box 604, processing logic determines whether any intermediate frames exist between the current frame and the random access frame found in the random access table (i.e., the nearest random access frame following the current frame). For example, if the current frame is frame 53 and the found random access frame from the random access table is frame 60, frames 54 through 59 are intermediate frames.

If the determination made at processing box 604 is negative (i.e., the found random access frame immediately follows the current frame), processing logic switches to the desired camera view at the found random access frame (processing block 606), decodes frames of the desired camera view, beginning with the found random access frame (processing block 608), and presents the decoded frames to the user (processing block 610).

Alternatively, if the determination made at processing box 604 is positive (i.e., there are intermediate frames between the current frame and the found random access frame), processing logic searches the random access table in the metadata track of the desired camera view for the nearest random access frame that precedes the current frame of the presently displayed camera view (processing block 612), and switches to the desired camera view at the random access frame found in the random access table (processing block 614).

Next, processing logic starts decoding frames of the desired camera view. In particular, processing logic begins with decoding the found random access frame (processing block 616). However, processing logic (e.g., processing logic residing in a scene compositor 212 of FIG. 2 or a frame transmitter sending decoded frames to a display system) causes the found random access frame not to be presented to the user (processing block 618). That is, processing logic skips the found random access frame when composing a scene to be displayed on a user display device or when transmitting decoded frames to an external display system.

Further, processing logic decodes the next frame of the desired view (processing block 620) and checks whether the timestamp of the current frame of the presently displayed frame is reached (processing box 622). If not, processing logic returns to processing block 618. If so, processing logic causes the next frame to be presented to the user (processing block 624) and then continues processing frames of the desired camera view until receiving a next switching request.

Accordingly, the user is provided with the capability of switching between multiple camera views in the real-time mode.

FIG. 7 is a flow diagram of one embodiment of a process 700 for performing a switching request pertaining to a pause mode. In one embodiment, process 700 is performed by components of a decoding system 200 (in particular, switching logic 204, a media decoder 210, a compositor 212, and a renderer 214) of FIG. 2.

Initially, process 700 begins with processing logic searching a random access table in a metadata track of a desired camera view for a random access frame that matches the current frame of the presently displayed camera view (processing block 702).

At processing box 704, processing logic determines whether a matching random access frame is found in the random access table. If so, processing logic switches to the desired camera view at the matching random access frame (processing block 706), decodes the matching random access frame (processing block 708), and presents the decoded frame to the user (processing block 710).

Alternatively, if the determination made at processing box 704 is negative, processing logic searches the random access table in the metadata track of the desired camera view for the nearest random access frame that precedes the current frame of the presently displayed camera view (processing block 712), and switches to the desired camera view at the preceding random access frame found in the random access table (processing block 714).

Next, processing logic decodes the found random access frame (processing block 716). However, processing logic (e.g., processing logic residing in a scene compositor 212 of FIG. 2 or a frame transmitter sending decoded frames to a display system) causes the found random access frame not to be presented to the user (processing block 618). That is, processing logic skips the found random access frame when composing a scene to be displayed on a user display device or when transmitting decoded frames to an external display system.

Further, processing logic determines whether any intermediate frames exist between the decoded frame and the current frame (processing box 718). If so, processing logic decodes the first intermediate frame (processing block 720) and returns to processing block 716. If not (i.e., the decoded frame matches the current frame of the presently displayed camera view), processing logic causes the decoded matching frame to be presented to the user (processing block 722).

Accordingly, the user is provided with the capability of switching between multiple camera views in the pause mode.

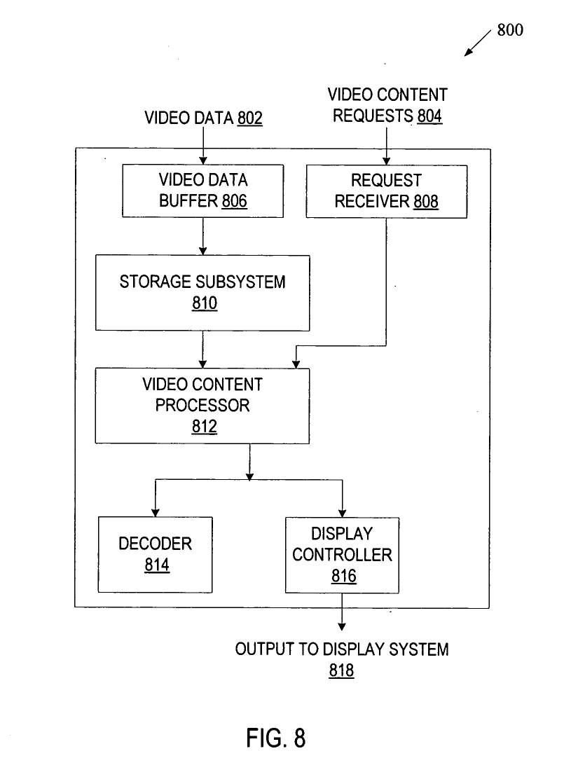

In some embodiments, consumer electronic devices are provided that support switching between multiple camera views at run time. FIG. 8 is a block diagram of one embodiment of a consumer electronic device 800 supporting switching between multiple camera views of a scene. A consumer electronic device 800 may be, for example, a personal video recorder (PVR) or a set-top box.

Referring to FIG. 8, the device 800 includes a video data buffer 806 that is responsible for receiving video data 802 via any of a number of known interfaces and sources, such as cable or satellite television networks or the Internet. The video data may represent “live” video transmitted by television networks or the Internet. The video data 802 includes video streams of scene views captured by cameras at different angles. In one embodiment, the video data 802 is already digitally encoded in the media file format (e.g., ISO base file format, MP4 file format, etc.) and includes metadata describing video streams. In an alternative embodiment, the video data 802 is initially provided as an analog signal and is digitized and encoded by an encoder (not shown) contained in the device 800 into the media file format.

The video data buffer 806 buffers the incoming digital video data 802 and provides the video data 802 to a storage subsystem 810. In one embodiment, the storage subsystem 810 includes a computer hard drive. The storage subsystem 810 stores the video data associated with multiple camera views in separate tracks. Hence, there are as many tracks stored in the storage subsystem 810 as there are views provided by the cameras for the scene. In addition, the storage subsystem 810 stores, for each camera view of the scene, metadata describing the corresponding video in a separate track associated with the track storing the corresponding video. In one embodiment, the metadata includes a random access table providing a list of random access frames within the video of the corresponding camera view. In one embodiment, the metadata also includes a timestamp table providing timestamps for all frames including the random access frame from the random access table (also referred to as a synchronization table).

The device 800 also includes a request receiver 808 that receives video content requests 804 submitted by a user. The video content requests may include time-shifting requests such as requests to pause viewing a “live” television broadcast to be able to resume viewing at a later time from the point at which live viewing was paused, requests to skip portions of a broadcast (e.g., commercials) while reviewing the broadcast, etc. The video content requests may also include view-shifting requests such as requests to switch between different camera views at run time or non-real time. In some embodiments, the video content requests may include time-shifting requests combined with view-shifting requests. For example, a user may request to switch to a different view while reviewing time-shifted broadcast.

The device 800 further includes a video content processor 812 that receives video content requests 804 and processes video data stored in the storage subsystem 810 according to the video content requests. For example, the video content processor 812 may respond to a reverse play request by retrieving a part of a “live” television broadcast recorded from the point at which live viewing was paused. The video content processor 812 may also process video data stored in the storage subsystem 810 according to view-shifting requests specified by a user. For example, the video content processor 812 may respond to a request for switching to a different camera view of the scene by finding a random access frame at which to switch and performing switching, as discussed in greater detail above. The switching may be performed both in the real-time mode and pause mode.

A video stream decoder 814 decodes frames provided by the video content processor 812 and passes the decoded frames to a display controller 120. The display controller 816 may also receive display instructions from the video content processor 812. The display instructions may indicate which frames should not be displayed, as discussed in greater detail above. The output provided by the display controller 816 is sent to a display device or an external display system (e.g., a television).

Accordingly, the device 800 allows a user to navigate through the time-shifted or stored video both in time and across views. By enabling the user to switch between camera views at run time, the device 800 provides the user with a realistic three-dimensional viewing experience.

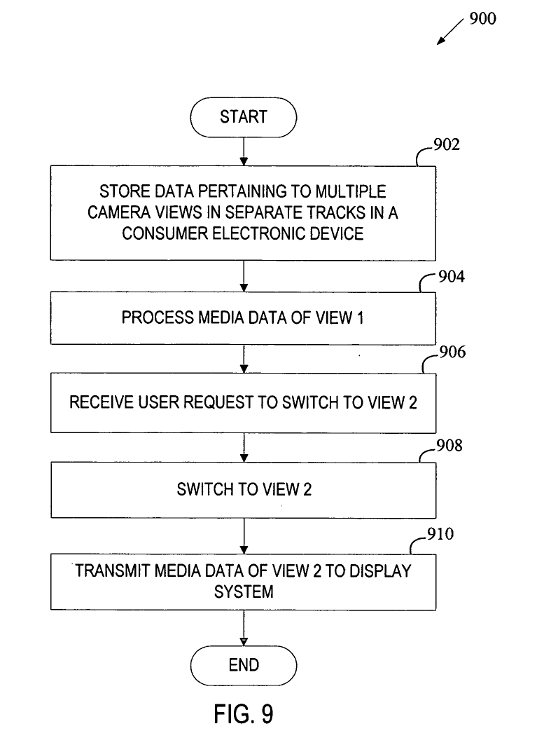

FIG. 9 is a flow diagram of one embodiment of a process 900 for switching between different camera views using a consumer electronic device. In one embodiment, process 900 is performed by a consumer electronic device 800 of FIG. 8.

Initially, process 900 begins with receiving and storing data pertaining to multiple camera views in separate tracks in a storage system of a consumer electronic device. The data pertaining to multiple camera views includes video encoded in a media file format (e.g., ISO base media file format, MP4 file format, etc.) and metadata describing the video. In one embodiment, the encoded video of each camera view is stored in a separate track and the corresponding metadata is stored in a separate track linked to the track of the relevant video.

Next, while processing encoded video of the presently displayed view of a scene (processing block 904), processing logic receives a user request to switch to a different camera view of the scene (processing logic 906). The user request may pertain to the real-time mode, asking for switching at a next frame of the desired camera view. Alternatively, the user request may pertain to a pause mode, asking for switching at the current frame of the desired camera view. In yet another example, the user request may pertain to a replay mode, asking for switching at a preceding frame of the desired camera view.

At processing block 908, processing logic switches to the desired camera view using switching functionality discussed in more detail above.

Afterwards, at processing block 910, processing logic identifies frames of the desired views that should be displayed to the user and transmits the identified frames to a display system.

Methods and systems for supporting switching between multiple camera views of a scene have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

What is claimed is:

1. A consumer electronic device comprising:
a storage sub-system to store multimedia data associated with a plurality of camera views of a scene and metadata describing the multimedia data associated with the plurality of camera views of the scene in separate tracks defined by a media file format, each of the separate tracks corresponding to one of the plurality of camera views of the scene; and
a content processor to switch between the plurality of views at run time using the metadata stored in the separate tracks.

2. The device of claim 1 wherein the consumer electronic device is anyone of a personal video recorder (PVR) and a set-top box.

3. The device of claim 1 wherein the storage sub-system comprises a hard drive.

4. The device of claim 1 wherein metadata stored in each of the separate tracks comprises a random access table providing a list of random access frames for a corresponding one of the plurality of camera views of the scene.

5. The device of claim 4 wherein the metadata stored in each of the separate tracks further comprises a timestamp table providing a timestamp for all frames including the random access frames in the list.

6. The device of claim 1 wherein the media file format is an International Organization for Standardization (ISO) base file format.

7. The device of claim 1 wherein each of the separate metadata tracks is associated with a camera position used for a corresponding one of the plurality of camera views.

8. The device of claim 1 wherein the content processor is to switch between the plurality of views by receiving a request to switch from a first view of the plurality of camera views to a second view of the plurality of camera views at run time, identifying a current frame of the first view, accessing a track associated with the second view to find a random access frame in the second view that is close in time to the current frame of the first view, and switching to the second view at the found random access frame.

9. The device of claim 8 wherein the request to switch pertains to a real-time mode.

10. The device of claim 9 wherein the content processor is to find the random access frame in the second view by searching a random access table associated with the second view for a random access frame following the current frame of the first view, determining whether any intermediate frames exist between the current frame of the first view and the following random access frame of the second view, and switching to the second view at the following random access frame if no intermediate frames exist between the current frame of the first view and the following random access frame of the second view.

11. The device of claim 10 further comprising:
a decoder to decode frames of the second view, starting with the following random access frame; and
a display controller to provide the decoded frames to a display system.

12. The device of claim 10 wherein the content processor is further to determine that at least one intermediate frame exists between the current frame of the first view and the following random access frame of the second view, and to search the random access table for a random access frame preceding the current frame of the first view.

13. The device of claim 12 further comprising:
a decoder to decode frames of the second camera view, starting with the preceding random access frame; and
a display controller to skip decoded frames until a timestamp of the current frame of the first view is reached, and to begin providing decoded frames to a display system when the timestamp following the current frame of the first view is reached.

14. The device of claim 8 wherein the request to switch pertains to a pause mode.

15. The device of claim 14 wherein the content processor is to find a random access frame in the second view by searching a random access table associated with the second view for a random access frame matching the current frame of the first camera view, and to switch to the second camera view at the matching random access frame if the matching random access frame exists in the random access table.

16. The device of claim 15 further comprising:
a decoder to decode the matching random access frame; and
a display controller to provide the decoded frame to a display system.

17. The device of claim 15 wherein the content processor is further to determine that a matching random access frame does not exist in the random access table, and to search the random access table associated with the second view for a random access frame preceding the current frame of the first view.

18. The device of claim 17 further comprising:
a decoder to decode intermediate frames of the second view, starting with the preceding random access frame and until reaching a frame that matches the current frame of the first camera view, and to decode the matching frame of the second camera view; and
a display controller to skip the decoded intermediate frames and to provide the decoded matching frame to a display system.

19. A method for a consumer electronic device, comprising:
storing multimedia data associated with a plurality of camera views of a scene and metadata describing the multimedia data associated with the plurality of camera views of the scene in separate tracks defined by a media file format, each of the separate tracks corresponding to one of the plurality of camera views of the scene; and
switching between the plurality of views at run time using the metadata.

20. The method of claim 19 wherein switching between the plurality of views comprises:
receiving a request to switch from a first camera view of the plurality of camera views to a second camera view of the plurality of camera views;
accessing one of the separate tracks storing metadata for the second camera view;
using the one of the separate tracks to find a random access frame in the second camera view that is close in time to a current frame of the first camera view; and
switching, at run time, to the second camera view at the found random access frame.

21. The method of claim 20 wherein the request to switch pertains to any one of a real-time mode, a pause mode, and a playback mode.

22. An apparatus comprising:
means for storing multimedia data associated with a plurality of camera views of a scene and metadata describing the multimedia data associated with the plurality of camera views of the scene in separate tracks defined by a media file format, each of the separate tracks corresponding to one of the plurality of camera views of the scene; and
means for switching between the plurality of views at run time using the metadata.

23. The apparatus of claim 22 wherein means for switching between the plurality of views comprises:
means for receiving a request to switch from a first camera view of the plurality of camera views to a second camera view of the plurality of camera views;
means for accessing one of the separate tracks storing metadata for the second camera view;
means for using the one of the separate tracks to find a random access frame in the second camera view that is close in time to a current frame of the first camera view; and
means for switching, at run time, to the second camera view at the found random access frame.

24. The apparatus of claim 23 wherein the request to switch pertains to any one of a real-time mode, a pause mode, and a playback mode.

25. A computer readable medium that provides instructions, which when executed on a processor cause the processor to perform a method comprising:
storing multimedia data associated with a plurality of camera views of a scene and metadata describing the multimedia data associated with the plurality of camera views of the scene in separate tracks defined by a media file format, each of the separate tracks corresponding to one of the plurality of camera views of the scene; and
switching between the plurality of views at run time using the metadata.

26. The computer readable medium of claim 25 wherein switching between the plurality of views comprises:
receiving a request to switch from a first camera view of the plurality of camera views to a second camera view of the plurality of camera views;
accessing one of the separate tracks storing metadata for the second camera view;
using the one of the separate tracks to find a random access frame in the second camera view that is close in time to a current frame of the first camera view; and
switching, at run time, to the second camera view at the found random access frame.

27. The computer readable medium of claim 26 wherein the request to switch pertains to any one of a real-time mode, a pause mode, and a playback mode.

28. A system comprising:
a memory; and
at least one processor coupled to the memory, the processor executing a set of instructions which cause the processor to
store multimedia data associated with a plurality of camera views of a scene and metadata describing the multimedia data associated with the plurality of camera views of the scene in separate tracks defined by a media file format, each of the separate tracks corresponding to one of the plurality of camera views of the scene, and
switch between the plurality of views at run time using the metadata.

29. The system of claim 28 wherein the processor is to switch between the plurality of views by receiving a request to switch from a first camera view of the plurality of camera views to a second camera view of the plurality of camera views, accessing one of the separate tracks storing metadata for the second camera view, using the one of the separate tracks to find a random access frame in the second camera view that is close in time to a current frame of the first camera view, and switching, at run time, to the second camera view at the found random access frame.

30. The system of claim 29 wherein the request to switch pertains to any one of a real-time mode, a pause mode, and a playback mode.
